(19) United States
(12) Patent Application Publication
(10) Pub. No.: US 2012/0248754 A1
(43) Pub. Date: Oct. 4, 2012

(54) APPOINTMENT BOOK

(76) Inventor: James Sartore, Albany, NY (US)

(21) Appl. No.: 13/246,303

(22) Filed: Sep. 27, 2011

Related U.S. Application Data
(63) Continuation-in-part of application No. 12/583,992, filed on Aug. 28, 2009, now abandoned.

(51) Int. Cl. B42D 5/04

(52) U.S. Cl. 283/2; 283/67

(57) ABSTRACT

An appointment book including a plurality of calendar sheets is provided. A monthly calendar may be inscribed on each of the monthly calendar sheets. A chart may be inscribed on each calendar sheet of the plurality of calendar sheets. The chart may have a plurality of rows and a plurality of columns. Each row may have a space means for receiving information regarding at least one of the date and time and a space means for receiving information about an event. The chart may also have a categorical indicia inscribed in each of the plurality of columns. The categorical indicia may include at least one of day, time, and appointment. A method of recording information in an appointment book is also provided. A method of manufacturing an appointment book is also provided.

### CROSS-REFERENCE TO RELATED APPLICATIONS

This application is a continuation in part of U.S. patent application titled APPOINTMENT BOOK having the Ser. No. 12/583,992 filed on Aug. 28, 2009 which is herein incorporated by reference in its entirety.

### TECHNICAL FIELD

This invention relates generally to the field of appointment books, schedules and calendars.

### BACKGROUND OF THE INVENTION

Appointment books are a tool that may be used to schedule and track appointments and events and maintain a semblance of order in people's lives. Often appointment books are made with spaces that are a predetermined size; the spaces are typically assigned a particular day and follow in consecutive order. The events on some days require a copious amount of writing, sometimes more than the space is capable of receiving. The events on other days may require few or no notes, and as a result the space is left blank and unused.

### SUMMARY OF THE INVENTION

The invention provides, in one aspect, an appointment book. The appointment book may include a plurality of calendar sheets. A monthly calendar may be inscribed on each calendar sheet of the plurality of calendar sheets. The appointment book may also include a chart inscribed on each calendar sheet of the plurality of calendar sheets. The chart may have a plurality of columns and a plurality of rows. Each row may have a space means for information regarding at least one of date and time and a space means for receiving information about an event. The appointment book may include categorical indicia inscribed in each of the plurality of columns, the categorical indicia including at least one of day, time and appointment. In another embodiment, the appointment book includes a chart, the chart having a space means for receiving information regarding the date, a space means for receiving information regarding the time and a space means for receiving information about the event. In another embodiment, the chart of the appointment book forms a grid. The chart may be inscribed below the monthly calendar on each calendar sheet of the plurality of calendar sheets. In another embodiment, the chart may include at least three columns. In another embodiment, the chart may include at least four rows. In another embodiment, the plurality of calendar sheets forms a yearly calendar. The width of a space means for receiving information about an event to occur at said at least one of date and time is a larger width than the space means for receiving information regarding at least one of date and time for the month inscribed on the sheet. In another embodiment of the invention, the space means for receiving information about an event to occur at least one of date and time is larger than the space means for receiving information regarding at least one of date and time for the month inscribed on said sheet. In another embodiment, the space means for receiving information regarding the date is substantially the same size as the space means for receiving information regarding time. The appointment book may also include a predetermined appointment symbol inscribed on the calendar sheet and the predetermined appointment symbol may be used to mark the monthly calendar. The appointment book may also include a predetermined appointment mark inscribed on the calendar sheet where the predetermined appointment mark is used to mark the monthly calendar.

The invention provides, in another aspect, a method of recording information in an appointment book, the appointment book including a plurality of calendar sheets, each calendar sheet of the plurality of the calendar sheets having a monthly calendar inscribed thereon. The appointment book may include a chart inscribed on each calendar sheet of the plurality of calendar sheets. The chart may have a plurality of columns and a plurality of rows. Each row may have a space means for receiving information regarding at least one of date and time and a space means for receiving information regarding an event. The appointment book may also include a categorical indicia inscribed in each of the plurality of columns, the categorical indicia may include at least one of day, time and appointment. The method may also include recording a date and/or time in the space means for receiving information regarding at least one of a date, a time and an event.

The method may also include inscribing at least one of date, time and information about an event in the chart. In one embodiment the date and time are nonchronological with other date and time inscriptions in the chart.

The invention provides, in another aspect, a method of manufacturing an appointment book. The method may include manufacturing an appointment book; the appointment book may include a plurality of calendar sheets. A monthly calendar may be inscribed on each calendar sheet of the plurality of calendar sheets. The appointment book may also include a chart inscribed on each calendar sheet of the plurality of calendar sheets. The chart may have a plurality of columns and a plurality of rows. Each row may have a space means for information regarding at least one of date and time and a space means for receiving information about an event. The appointment book may include categorical indicia inscribed in each of the plurality of columns, the categorical indicia including at least one of day, time and appointment. In another embodiment, the appointment book includes a chart, the chart having a space means for receiving information regarding the date, a space means for receiving information regarding the time and a space means for receiving information about the event.

Other additional features and benefits will become apparent from the following drawings and descriptions of the invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the end of the specification. The foregoing and other features and advantages of the invention are apparent from the following detailed description taken in conjunction with the accompanying drawings in which:

FIG. 1 is a perspective view of an appointment book, in accordance with an aspect of the invention.

### DETAILED DESCRIPTION FOR CARRYING OUT THE INVENTION

For the purposes of promoting an understanding of the principles of the appointment book, reference will now be made to the embodiments, or examples, illustrated in the drawings and specific language will be used to describe these. It will nevertheless be understood that no limitation of the scope of the invention is thereby intended. Any alterations and further modifications in the described embodiments, and any further applications of the principles of the invention as described herein are contemplated as would normally occur to one skilled in the art to which the appointment book invention relates.

Present appointment books and calendars provide spaces of predetermined size. On some occasions, a user will desire to include only a limited amount of information in the space, leaving much of the space empty. On other occasions, a user will have a lot of information to include in a space for a given day, and the space will not be large enough to include all of the information. In the first instance there is a waste of space and in the second instance the user does not have enough space to include all of the desired information. In contrast, the present appointment book provides for a chart to be included on a page with a calendar. The user of the appointment book can include as much information or as little information as desired with little wasted space while having as much room as needed. Because excess space is not unnecessarily devoted to specific days, the appointment book may be made in a small size.

The chart may be utilized with the placement of any date and/or time in the chart, followed by as much or as little information about the event or appointment as desired. The dates can be placed in the cart in any order desired. In addition, the days of the calendar can be marked with an indicia, for example a circle, an “x”, a hash mark, a square or similar mark to indicate that an appointment or event is occurring on a given day.

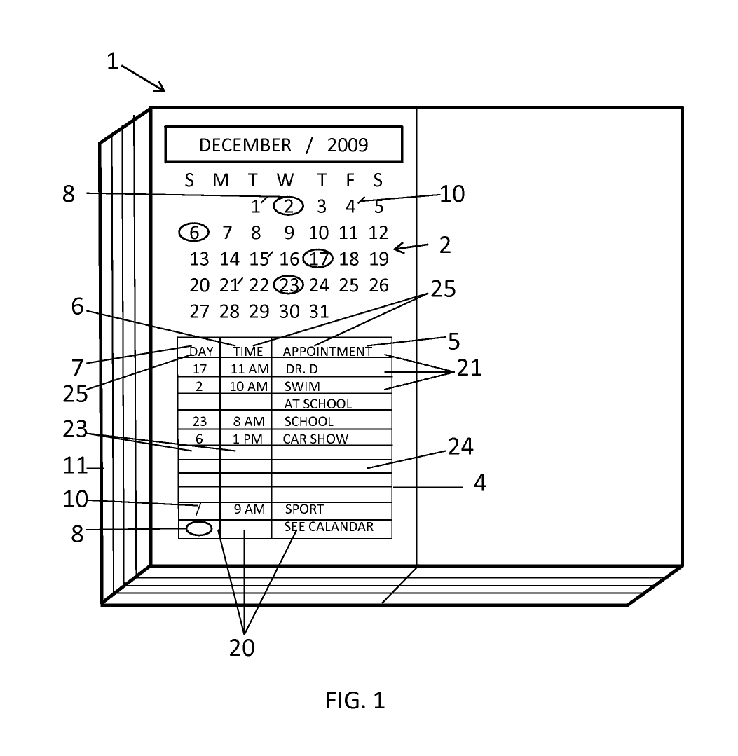

Referring now to FIG. 1, an appointment book 1 of the present invention is shown. The appointment book 1 may include a plurality of calendar sheets 11. A calendar 2 may be inscribed on each of the calendar sheets 11. A chart 4 may also be inscribed on each of the calendar sheets 11. The chart 4 may have a plurality of columns 20 and a plurality of rows 21. Each row 21 may have at least one space means 23 for receiving information regarding at least one of date and time and at least one space means 24 for receiving information regarding information about an event. The chart 4 may include at least one categorical indicia 25 which is inscribed in each of the plurality of columns 20, the categorical indicia 25 including at least one of day 7, time 6, and appointment 5.

In at least one alternative embodiment, the appointment book 1 may include a space means 23 for receiving information regarding the date, a space means 23 for receiving information regarding the time, and a space means 24 for receiving information about the event.

The appointment book 1 may also include at least one predetermined appointment symbol 8 which is inscribed in a space means 23 for receiving information regarding at least one of date and time. The appointment symbol 8 may be, for example, a circle, square, “x” mark of other means of identifying a specific date on which an event occurs. The event symbol 8 may also be inscribed about, through, or near an appointment day on the calendar 2. Alternatively, the event symbol 8 may be placed about, through, or near multiple appointment days to indicate an appointment that spans several days. In an alternative embodiment one or more appointment symbols 8 may be selected by a user and inscribed in space means 23 for receiving information regarding at least one of date and time.

The appointment book 1 may also be inscribed with at least one predetermined appointment mark 10 which is in a space means 23 for receiving information regarding at least one of date and time. Appointment mark 10 may be, for example, a slash, a hyphen an asterisk or other similar mark. Appointment mark 10 may be placed near an appointment day on calendar 2 to indicate a repeating event. In alternative embodiments, one or more appointment marks 10 may be selected by a user and inscribed in space means 23 for receiving information regarding at least one of date and time.

In another aspect of the invention, a method of recording information is provided. The method may include providing an appointment book as described herein and recording at least one of a date and a time and recording information regarding an event. The date and/or time may be recorded in the space means 23 for receiving information regarding at least one of date and time. The event information may be recorded in the space means 24 for receiving information regarding information about an event.

A user may manipulate the appointment book 1 of the present invention to record relevant data concerning upcoming appointments and events. Upon learning of an appointment or event that the user would like to attend, the user may view the appointment book 1. The user may then inscribe in chart 4 information regarding the date and/or time and other notes concerning the appointment. The information regarding the date and/or time may be recorded in the space means 23 for receiving information regarding at least one of date and time. The user may make further notes regarding the appointment or event in a space means 24 for receiving information about an event. The user may then mark the calendar with a predetermined appointment symbol 8 or make another notation on the calendar 2. Upon receiving information regarding an additional event or appointment, the user may repeat the steps to record additional information and determine conflicts with prior scheduled appointments and events.

If a user receives information regarding a repeating event, the user may make a predetermined appointment mark 10 in the chart and regard information about the appointment or event in the space means 23 for receiving information regarding at least one of date and time and in space means 24 for receiving information about an event. The user may then inscribe predetermined appointment mark 10 on calendar 2 to denote the dates that the repeating event occurs on.

Referring again to FIG. 1, an example schedule is shown. First, an appointment may be scheduled for December 17. A user may circle or otherwise mark monthly calendar 2 with appointment symbol 8 on December 17. The user may also inscribe or otherwise write the day in the chart in space means 23 for receiving information regarding at least one of date and time. The user may also inscribe or write the time in space means 23 for receiving information regarding at least one of date and time. The user may also inscribe or write other additional information in the chart in space means 24 for receiving information about an event. Subsequently, the user may have another appointment or event that he wishes to attend. For example, the user may schedule a swim at school. As such the user may inscribe the day and time in space means 23 for receiving information regarding at least one of date and time and other information about the event in space means 24 for receiving information about an event. As shown in FIG. 1, more than one space means 24 for receiving information about an event may be used if necessary. The user may review both the monthly calendar 2 and the chart 4 to determined if there is a conflicting appointment or event.

Still referring to FIG. 1 as an example, the user may have further events such as school at 8 AM on December 23, or alternatively a car show on December 6 at 1 PM. This information may be inscribed in space means 24 for receiving information about an event and space means 23 for receiving information regarding at least one of date and time as necessary, using as much or as little space in chart 4 as necessary. Still referring to FIG. 1, the chart may include, for example, a predetermined appointment symbol 8. The appointment symbol 8 may be inscribed on the chart by a manufacturer or may be selected and inscribed by a user. The appointment symbol 8 may be inscribed in space means 23 for receiving information regarding at least one of date and time and information regarding the appointment symbol 8 may be inscribed in space means 24 for receiving information about an event. As another example, the chart may include a predetermined appointment mark 10. Appointment mark 10 may be inscribed in space means 23 for receiving information regarding at least one of date and time and additional information may be inscribed in chart 4 as necessary. For example, the time, 9 AM may be inscribed and sport may be inscribed to describe the event or appointment.

In another aspect of the invention, a method of manufacturing an appointment book may include manufacturing an appointment book as described herein.

While embodiments of the invention have been illustrated and described in detail in the disclosure, the disclosure is to be considered as illustrative and not restrictive in character. All changes and modifications that come within the spirit of the invention are to be considered within the scope of the disclosure.

1. An appointment book comprising:
a plurality of calendar sheets, each calendar sheet of the plurality of calendar sheets having a monthly calendar inscribed thereon;
a chart inscribed on each calendar sheet of the plurality of calendar sheets, the chart having a plurality of columns and a plurality of rows, each row having a space means for receiving information regarding at least one of date and time for the month inscribed on said sheet and a space means for receiving information about an event to occur at said at least one of date and time; and
a categorical indicia inscribed in each of the plurality of columns, the categorical indicia including at least one of day, time and appointment.

2. The appointment book of claim 1, wherein the chart comprises a space means for receiving information regarding the date, a space means for receiving information regarding the time and a space means for receiving information about the event.

3. The appointment book of claim 1, wherein the chart forms a grid.

4. The appointment book of claim 1, wherein the chart is inscribed below the monthly calendar on each calendar sheet of the plurality of calendar sheets.

5. The appointment book of claim 1, wherein the chart comprises at least three columns.

6. The appointment book of claim 1, wherein the chart comprises at least four rows.

7. The appointment book of claim 1, wherein the plurality of calendar sheets forms a yearly calendar.

8. The appointment book of claim 1, wherein a width of the space means for receiving information about an event to occur at said at least one of date and time is larger than a width of the space means for receiving information regarding at least one of date and time for the month inscribed on said sheet.

9. The appointment book of claim 1, wherein the space means for receiving information about an event to occur at said at least one of date and time is larger than the space means for receiving information regarding at least one of date and time for the month inscribed on said sheet.

10. The appointment book of claim 2, wherein the space means for receiving information regarding the date is substantially the same size as the space means for receiving information regarding the time.

11. The appointment book of claim 2, wherein the space means for receiving information regarding the date is smaller than the substantially the same size as the space means for receiving information regarding the time.

12. The appointment book of claim 1, further comprising a predetermined appointment symbol inscribed on the calendar sheet where the predetermined appointment symbol is used to mark the monthly calendar.

13. The appointment book of claim 1, further comprising a predetermined appointment mark inscribed on the calendar sheet where the predetermined appointment mark is used to mark the monthly calendar.

14. A method of recording information in an appointment book comprising:
providing an appointment book comprising:
a plurality of calendar sheets, each calendar sheet of the plurality of calendar sheets having a monthly calendar inscribed thereon;
a chart inscribed on each calendar sheet of the plurality of calendar sheets, the chart having a plurality of columns and a plurality of rows, each row having a space means for receiving information regarding at least one of date and time for the month inscribed in said sheet and a space means for receiving information about an event to occur at said at least one of date and time; and
a categorical indicia inscribed in each of the plurality of columns, the categorical indicia including at least one of day, time and appointment.
recording at least one of date and time in the space means for receiving information regarding at least one of date and time.

15. The method of claim 14, further comprising inscribing at least one of date, time, and information about an event in the chart.

16. The method of claim 15, wherein the date and time are nonchronological with other date and time inscriptions in the chart.

17. A method of manufacturing an appointment book comprising:
Manufacturing an appointment book comprising:
a plurality of calendar sheets, each calendar sheet of the plurality of calendar sheets having a monthly calendar inscribed thereon;
a chart inscribed on each calendar sheet of the plurality of calendar sheets, the chart having a plurality of columns and a plurality of rows, each row having a space means for receiving information regarding at least one of date and time for the month inscribed in said sheet and a space means for receiving information about an event to occur at said at least one of date and time; and
a categorical indicia inscribed in each of the plurality of columns, the categorical indicia including at least one of day, time and appointment.
